(19) United States
(12) Patent Application Publication
(10) Pub. No.: US 2022/0389714 A1
(43) Pub. Date: Dec. 8, 2022

(54) Binding Structure and Mounting Device

(71) Applicant: CMC Elements ApS, Silkeborg (DK)

(72) Inventor: Ole CLEMENT, Silkeborg (DK)

(21) Appl. No.: 17/867,888

(22) Filed: Jul. 19, 2022

Related U.S. Application Data
(63) Continuation of application No. PCT/DK2021/050019, filed on Jan. 21, 2021.

(30) Foreign Application Priority Data
Feb. 5, 2020 (DK) PA 2020 00147

(51) Int. Cl. E04C 5/16; E04G 21/12; B25B 25/00

(52) U.S. Cl. CPC E04C 5/167; E04G 21/123; B25B 25/00

(57) ABSTRACT

A binding structure for attaching two structures to each other, said binding structure comprising an elongated body portion having a first end portion and a second end portion. A head portion is provided in the first end portion and in the second end portion, wherein said head portion protrudes radially from (at least a portion of) the body portion.

### CROSS REFERENCE TO RELATED APPLICATIONS

This application is a continuation under 35 U.S.C. 111 of International Patent Application No. PCT/DK2021/050019, filed Jan. 21, 2021, which claims the benefit of and priority to Danish Application No. PA 2020 00147, filed Feb. 5, 2020, each of which is hereby incorporated by reference in its entirety.

### FIELD OF INVENTION

The present invention relates to a binding structure (locking tie) for attaching two structures such as steel reinforcements to each other, wherein said binding structure comprises an elongated body portion having a first end portion and a second end portion. The present invention also relates to a method for locking structures to each other by using a binding structure. The present invention moreover relates to a mounting device for mounting a binding structure according to the invention.

### BACKGROUND

In many structural concrete constructions, it is required to use (steel) reinforcement (e.g. rebars) in the associated concrete work. There are several ways to tie the rebars. Often, the (steel) reinforcement (e.g. rebars) is tied with annealed steel wire, either bought in bulk rolls, or if using a bag tie spinner, in bundles of pre-cut wire pieces with loops formed on both ends. The latter is considered to be easier for novices to use, but somewhat more expensive, the former is often the choice of experienced rebar tiers (rodbusters). Attachment of the known attachment structures requires, however, application of two arms. Accordingly, it would be desirable to have an alternative binder that can be attached with a single hand.

U.S. Pat. No. 2,004,702 discloses an elastic lace adapted for use in connection with boots and shoes. The elastic shoelace has on each end thereof an arrow-shaped anchoring head of resilient material. Accordingly, the elastic shoelace is easy to insert in the eyelet of the boot or shoe and will after insertion automatically assume an anchoring position with respect to the eyelet which will cause no discomfort to the user.

DE202012103866U1 discloses a binder element for fastening two elongated bodies to each other. The binder element is adapted for fastening a plant part on a tension wire. The binder element comprises an eyelet made by an elastic material and a hooking head connected to the eyelet.

US20180266110A1 discloses a method for securing rebar prior to concrete pour consisting of tying completely by hand, in a series of unique steps, a piece of gauge steel wire with two loops on either end around the rebar intersections.

None of these prior art documents provide practical solutions that can be attached fast enough.

Thus, there is a need for an improved binding structure that enables an easier and faster attachment of reinforcement structures (such as rebars) to each other.

### BRIEF DESCRIPTION

It is an object of the invention to provide an improved binding structure that enables an easier and faster attachment of reinforcement structures (such as rebars) to each other. It is also an object of the invention to provide a mounting device configured to tie together such binding structure.

The object of the present invention can be achieved by a binding structure assembly that comprises a plurality of binding structures, wherein the binding structures are configured for attaching two structures to each other, said binding structure comprising an elongated body portion having a first end portion and a second end portion, wherein a head portion is provided in the first end portion and in the second end portion, wherein said head portions protrude radially from at least a portion of the body portion, wherein the binding structure assembly is provided in a sheet-like structure.

Hereby, it is possible to provide a binding structure assembly that enables an easier and faster attachment of reinforcement structures (such as rebars) to each other than the prior art solutions. Moreover, it is possible to transport, store and handle the binding structure assembly in a manner in which the relative position of the binding structures can be maintained.

The binding structure is configured to be used for attaching two or more structures to each other. Such structures may in particular be rebars in a concrete construction.

The binding structure comprises an elongated body portion having a first end portion and a second end portion. The elongated body portion may be a structure having a uniform cross section.

The binding structure according to the invention is a binding structure configured to attach two structures to each other, wherein the binding structure comprises an elongated body portion having a first end portion and a second end portion, wherein a head portion is provided in the first end portion and in the second end portion, wherein said head portions protrude radially from at least a portion of the body portion.

The cross section of the body portion may have any suitable geometry. In an embodiment, the cross section of the body portion is rectangular.

In an embodiment, the cross-sectional area of the body portion is circular.

In an embodiment, the cross-sectional area of the body portion is oval.

A head portion is provided in the first end portion and in the second end portion, wherein said head portion protrudes radially from (at least a portion of) the body portion. A head portion is defined as a structure having a larger width than the adjacent portion of the body portion that is arranged next to the head portion.

Typically, the head portion is made as a mass of material. Hereby, it is possible to compress the head portion without deforming the head portion.

In an embodiment, the binding structure is massive so that the head portions are resistant to compressive forces and thus can be held by a mounting device hereby allowing a fast attachment of the binding structures to structures such as rebars for a concrete construction.

It may be advantageous that the binding structure is made by a stamping, cutting or punching process. Hereby, it is possible to produce the binding structures by punching, cutting or stamping them out from a sheet material, preferably a metal sheet material.

It may be beneficial that the stamping, cutting or punching process is followed by a subsequent mechanical process, in which a plurality of binding structures are arranged sided by side, wherein adjacent binding structures are attached to each other using a suitable attachment method.

In an embodiment, the binding structures are combined into a binding structure assembly using a joining agent to join adjacent binding structures.

In an embodiment, the joining agent is glue. In an embodiment, the joining agent is paper based.

In an embodiment, the joining agent is plastic-based such as hot melt.

In an embodiment, the adjacent binding structures are joined using mechanical attachment structures.

In an embodiment, the adjacent binding structures are joined using micro joints, which are small structures extending between adjacent head portions of adjacent binding structures.

In an embodiment, the binding structure assembly manufacturing process comprises the step of providing a plurality of binding structures from a sheet material, such as a metal sheet material.

In an embodiment, each binding structure is deformed by a mechanical deformation process. Such process may involve a tool that is applied to provide an impact on either side of the binding structure, in such a manner that the deformation leads to the formation of a first head portion and a second head portion.

In an embodiment, the deformation process is carried out by exposing each binding structure to a force extending along the length of the binding structure, wherein the force is directed towards the free ends of the binding structure. In an embodiment, both free ends of a binding structure are simultaneously exposed to a force extending along the length of the binding structure towards the central portion of the binding structure.

It may be an advantage that the binding structure comprises an intermediate structure provided between the first end portion and the second end portion, wherein the width of a portion of the intermediate structure is smaller than the width of the head portion.

In an embodiment, the body portion constitutes the intermediate structure.

In an embodiment, a portion of the body portion constitutes the intermediate structure.

In an embodiment, the intermediate structure has a width of 0.3-5 mm. In an embodiment, the intermediate structure has a width of 0.5-3 mm. In an embodiment, the intermediate structure has a width of 1-2 mm.

It may be beneficial that the elongated body portion comprises a uniform cross section. Hereby, it is possible to manufacture the body portion from a standard sheet material having a uniform cross section.

It may be an advantage that the elongated body portion is provided with a narrow portion having a smaller width than the remaining part of the elongated body portion. Hereby, it is possible to predefine where the bending will occur. This may be an advantage when a pre-defined bending area is required or beneficial.

In an embodiment, the narrow portion has a width that is 80% or less of the width of the internal structure. In an embodiment, the narrow portion has a width that is 70% or less of the width of the internal structure. In an embodiment, the narrow portion has a width that is 60% or less of the width of the internal structure. In an embodiment, the narrow portion has a width that is 50% or less of the width of the internal structure. In an embodiment, the narrow portion has a width that is 40% or less of the width of the internal structure.

It may be advantageous that the binding structure is made of metal.

In an embodiment, the binding structure is made of steel. In another embodiment, the binding structure is made of aluminium.

It may be advantageous that the binding structure is made of heat-treated steel.

In an embodiment, the binding structure is made of annealed steel.

In an embodiment, the binding structure is made of calcined steel.

By the term sheet-like structure is meant that the binding structures are arranged in a manner, in which the binding structures extend or can be arranged in a configuration, in which the binding structures extend in the same plane. Accordingly, several binding structure assemblies may be stacked. Thus, it is possible to store the binding structures in a manner in which a limited amount of space is required.

In an embodiment, the binding structures are basically straight and extend parallel to each other.

It may be advantageous that the binding structures have the same geometry and length and are provided next to each other.

Typically, the binding structures extend in the same direction so that the longitudinal axes of the binding structures extend parallel to each other.

In an embodiment, the binding structures in the binding structure assembly are arranged in such a manner that:
a) the binding structures extend parallel to each other so that the longitudinal axes of the binding structures are parallel and
b) the head portions of adjacent binding structures extend along a line that is angled with an angle different from 90 degrees relative to the longitudinal axes of the binding structures

In an embodiment, the angle is in the range 92-15 degrees. In an embodiment, the angle is in the range 95-130 degrees. In an embodiment, the angle is in the range 100-120 degrees.

Thus, larger flexibility when storing the binding structures is achieved.

It may be an advantage that a micro joint is provided between adjacent head portions. Hereby, it is possible to maintain the binding structures in a fixed position relative to each other. At the same time, the micro joint makes it possible to detach two adjacent binding structures from each other.

Typically, adjacent binding structures are fixed to each other by a first micro joint.

Typically, adjacent binding structures are fixed to each other by a first micro joint and a second micro joint.

In an embodiment, the binding structures are fixed to each other by a first micro joint provided in the first head portion and by a second micro joint provided in the second head portion.

In an embodiment, the micro joints extend perpendicular to the longitudinal axis of the binding structure. In an embodiment, the thickness of the micro joints is 0.001-2.0 mm. In another embodiment, the thickness of the micro joints is 0.002-1.0 mm. In a further embodiment, the thickness of the micro joints is 0.004-0.8 mm.

A typical mounting device used for securing rebar ties is the so-called rebar hook tool. The tool works by having a hook attached to a rotatable telescopic pole (a rotation member). The user places the ties around the desired area and then places the hook under the ties, and by pulling away from the ties, the hook gets into contact with the rebar ties while spinning thus tying together the ties such that they are secure.

As the invention describes new binder structures and binding structure assemblies, it is also desirable to provide a device that is configured to mount binding structures of the binding structure assembly according to the invention.

The mounting device according to the invention is a mounting device configured and arranged to tie together a binding structure of a binding structure assembly according to the invention, wherein the mounting device comprises a gripping portion configured to receive and hold the head portions of the binding structure, wherein the mounting device comprises a rotation member configured to rotate the gripping portion upon displacing the rotation member along the longitudinal axis of the mounting device, wherein the gripping portion is configured to, upon displacing the rotation member along the longitudinal axis of the mounting device, be automatically (during use of the mounting device) arranged in:
a) a closed configuration, in which the gripping portion maintains the binding structure and
b) an open configuration, in which the gripping portion releases the binding structure, wherein the open configuration is achieved upon further displacing the rotation member along the longitudinal axis of the mounting device when the mounting device has initially been arranged in the closed configuration.

Hereby, it is possible to provide a mounting device that can be used to tie together a binding structure according to the invention in a fast and user-friendly manner.

In an embodiment, the gripping portion comprises:
a first base portion rotatably attached to a joint member by means of a first shaft and
a second base portion rotatably attached to the joint member by means of a second shaft, wherein the first shaft and the second shaft extend parallel to each other.

In an embodiment, a spring extends between the first base portion and the second base portion. Hereby, the gripping portion can be kept in a closed configuration in an easy and reliable manner.

In an embodiment, each base portion comprises a receiving opening configured to simultaneously receive:
a part of a first head portion of the binding structure and
a part of the other head portion of the binding structure,
   wherein the receiving opening is equipped with:
a first recess configured to receive and maintain said part of the first head portion of the binding structure in a fixed position of the base portion and
a second recess configured to receive and maintain said part of the second head portion of the binding structure in a fixed position of the base portion.

In an embodiment, the gripping portion comprises two base portions attached to a rotatable telescopic pole of a rebar hook tool.

In an embodiment, the mounting device comprises a helical structure extending between the base portion and an end structure provided in the proximal end of the mounting device.

In an embodiment, the mounting device comprises a rotation member comprising a helical structure extending inside a surrounding spring. In an embodiment, the helical structure is rotatably mounted in a bearing that is mounted in a bearing housing.

In an embodiment, the distal end of the helical structure is attached to a stag that is attached to the bearing.

In an embodiment, the mounting device comprises a profiled member surrounding the helical structure and having a profile that matches the geometry of the cross-sectional profile of the helical structure. Accordingly, when the profiled member is pulled along the longitudinal axis of the mounting device, the helical structure will be rotated due to the retraction of the profiled member.

In an embodiment, the helical structure is attached to a guide structure that is attached to a joint member. In an embodiment, the joint member is attached to the base portions. In an embodiment, a metal plate and a resilient member formed as a rubber plate are sandwiched between the guide structure and the joint member.

In an embodiment, the mounting device comprises a pull structure that is attached to the profiled member, wherein the pull structure is arranged and configured to translate the profiled member along the length of the mounting device. Accordingly, when the pull structure and the profiled member are displaced along the length of the mounting device, the helical structure will be rotated and thus the base portions will be rotated with the same rotational velocity as the helical structure. Thus, the mounting device can easily mount binding structures according to the invention and release the binding structure when mounted. The surrounding spring will return the pull structure to its starting position.

In a further embodiment, the receiving portion comprises two bracket structures, wherein the bracket structures are basically L-shaped and comprise two parallel holding structures. In an embodiment, the holding structures are plate structures.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a schematic view of a portion of a binding structure according to the invention;

FIG. 1B shows a schematic view of a portion of another binding structure according to the invention;

FIG. 1C shows a schematic view of a portion of a further binding structure according to the invention;

FIG. 1D shows a schematic view of a portion of another binding structure according to the invention;

FIG. 1E shows a schematic view of a portion of a further binding structure according to the invention;

FIG. 1F shows a schematic view of a portion of an even further binding structure according to the invention;

FIG. 2A shows a view of how reinforcement structures are being attached to each other using a prior art steel wire;

FIG. 2B shows another view of attaching reinforcement structures to each other using a steel wire;

FIG. 3A shows a perspective view of a binding structure assembly according to the invention;

FIG. 3B shows a perspective view of a binding structure from the binding structure assembly shown in FIG. 3A;

FIG. 4A shows a perspective view of a binding structure assembly according to the invention;

FIG. 4B shows a close-up view of a portion of the binding structure assembly shown in FIG. 4A;

FIG. 4C shows a close-up view of a portion of a binding structure according to the invention;

FIG. 5 shows a front view of a binding structure assembly according to the invention;

FIG. 6 shows steps of a process for manufacturing a binding structure assembly according to the invention;

FIG. 7A shows a perspective view of a binding structure according to the invention arranged in a mounting device;

FIG. 7B shows a close-up view of an end portion of a binding structure arranged in the mounting device shown in FIG. 5A;

FIG. 8A shows a base portion of a mounting device according to the invention;

FIG. 8B shows two base portions of a mounting device according to the invention in a configuration in which no binding structure has been attached to the base portions;

FIG. 8C shows the two base portions shown in FIG. 8B, in a configuration in which a binding structure has been attached to the base portions;

FIG. 8D shows the two base portions shown in FIG. 8B and FIG. 8C, in a configuration in which the base portions have released the binding structure;

FIG. 8E shows the two base portions shown in FIG. 8D, in a configuration in which the base portions have been removed from the binding structure;

FIG. 9A shows a metal sheet from which binding structures according to the invention can be made;

FIG. 9B shows a binding structure assembly made from the metal sheet shown in FIG. 9A after a punching process has been carried out;

FIG. 9C shows a close-up view of a portion of a binding structure from the binding structure assembly shown in FIG. 9B;

FIG. 9D shows the binding structure shown in FIG. 9C in a configuration in which the side portions of the elongated body portion have been bent;

FIG. 9E shows a cross-sectional view of the elongated body portion of the binding structure shown in FIG. 9C;

FIG. 9F shows a cross-sectional view of the elongated body portion of the binding structure shown in FIG. 9D;

FIG. 9G shows a cross-sectional view of two binding structures each having an elongated body portion like the binding structure shown in FIG. 9D;

FIG. 9H shows a cross-sectional view of two binding structures according to an embodiment of the invention;

FIG. 9I shows a cross-sectional view of the elongated body portion of a binding structure shown in FIG. 9H;

FIG. 10A shows a mounting device according to the invention;

FIG. 10B shows a view of the mounting device shown in FIG. 10A;

FIG. 10C shows a close-up view of the mounting device shown in FIG. 10A and FIG. 10B;

FIG. 10D shows a close-up view of a joint member and two base portions of a mounting device according to the invention; and

FIG. 11 shows a side view of two base portions of a mounting device corresponding to the one shown in FIG. 10A, FIG. 10B, FIG. 10C.

### DETAILED DESCRIPTION

Referring now in detail to the drawings for the purpose of illustrating preferred embodiments of the present invention.

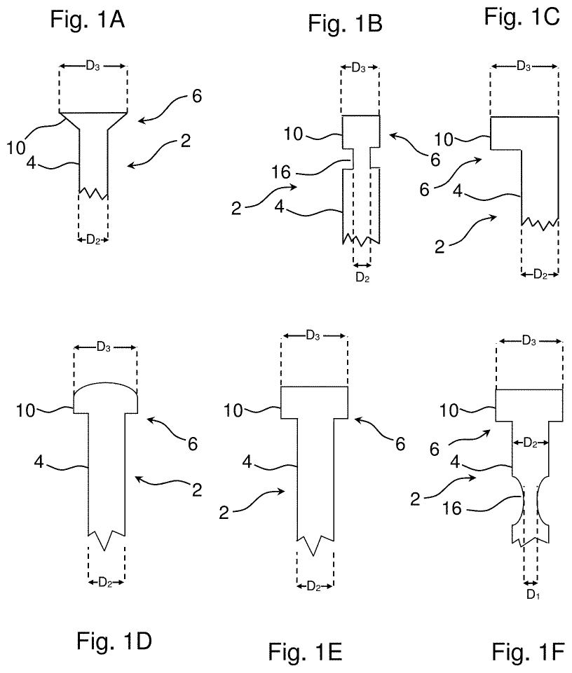

FIG. 1A illustrates a schematic view of a portion of a binding structure 2 according to the invention. The binding structure 2 comprises an elongated body portion 4 extending between a first head portion 10 and a second head portion (not shown). It can be seen that the head portion 10 protrudes from the body portion 4 and that the width D₃ of the head portion 10 is larger than the width D₂ of the body portion 4. The first head portion 10 is arranged at the first end portion 6 of the binding structure 2. Likewise, the second head portion (not shown) is arranged at a second end portion (not shown) provided at the opposite end than the first end portion 6 of the binding structure 2.

The head portion 10 has a conical geometry. In an embodiment, the cross-sectional area of the head portion 10 is circular. In another embodiment, the cross-sectional area of the head portion 10 is rectangular (e.g. square). In a further embodiment, the cross-sectional area of the head portion 10 is oval.

By having a head portion 10 that protrudes from the body portion 4, it is possible to hold the binding structure 2 using the head portion 10.

FIG. 1B illustrates a schematic view of a portion of another binding structure 2 according to the invention. The binding structure 2 comprises an elongated body portion 4 extending between a first head portion 10 and a second head portion (not shown) arranged at the opposite end of the binding structure 2. The head portion 10 protrudes from the body portion 4 and the width D₃ of the head portion 10 is larger than the width D₂ of a narrow portion 16 of the body portion 4. The first head portion 10 is arranged at the first end portion 6 of the binding structure 2 and the second head portion (not shown) is arranged at the opposite (second) end portion (not shown) of the binding structure 2.

The head portion 10 has a rectangular cross-sectional area. The narrow portion 16 is provided between two adjacent portions having the same width D₃.

The head portion 10 protruding from the body portion 4 enables the head portion 10 to be used to fix the binding structure 2 to (e.g. a receiving structure of) a tool.

FIG. 1C illustrates a schematic view of a portion of a further binding structure 2 according to the invention. The binding structure 2 comprises an elongated body portion 4 extending between a first head portion 10 and a second head portion which is not shown, but is arranged at the opposite end of the binding structure 2. The head portion 10 protrudes from the body portion 4 so that the first end portion 6 of the binding structure 2 constitutes an L-shaped portion.

The width D₃ of the head portion 10 is approximately twice as large as the width D₂ of the body portion 4. The first head portion 10 is arranged at the first end portion 6 of the binding structure 2.

In an embodiment, the head portion 10 has a rectangular cross-sectional area. In another embodiment, the head portion 10 has a circular or oval cross-sectional area.

The protruding portion of the head portion 10 can be used to fix the binding structure 2 to (e.g. a receiving structure of) a tool. Hereby, the use of a hand to hold the binding structure 2 can be eliminated.

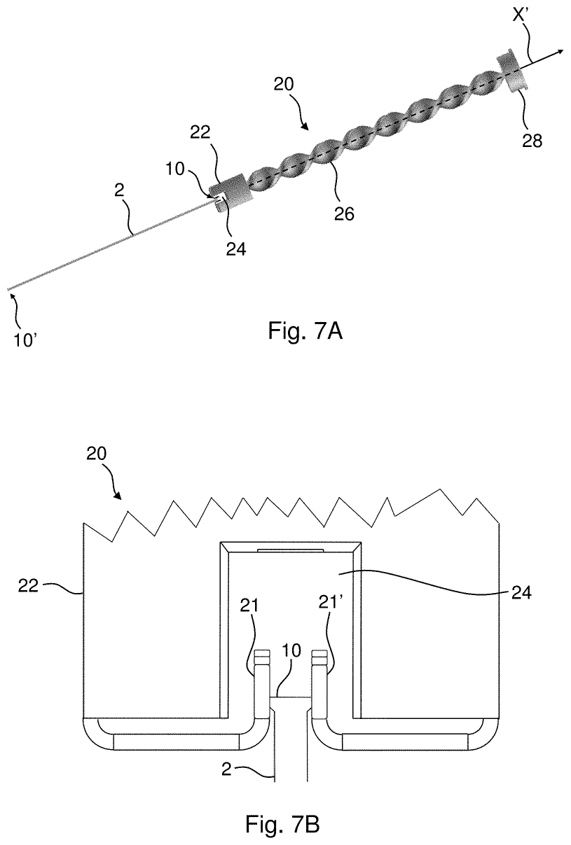

FIG. 1D illustrates a schematic view of a portion of another binding structure 2 according to the invention. The binding structure 2 comprises an elongated body portion 4 that is sandwiched between a first head portion 10 and a second head portion (not shown). The head portion 10 protrudes from the body portion 4. The width D₃ of the head portion 10 is larger than the width D₂ of the body portion 4. Accordingly, it is possible to hold the binding structure 2 (e.g. in a mounting tool shown in FIG. 7A) using the head portion 10.

The first head portion 10 is arranged at the first end portion 6 of the binding structure 2. The second head portion (which is not shown) is arranged at a second end portion (not shown) provided at the opposite end than the first end portion 6 of the binding structure 2.

FIG. 1E illustrates a schematic view of a portion of a further binding structure 2 according to the invention. The binding structure 2 basically corresponds to the one shown in FIG. 1D. The first head portion 10 is, however, shaped slightly differently. Whereas in FIG. 1D, the top portion of the first head portion 10 is arced, the first head portion 10 is flat in FIG. 1E.

FIG. 1F illustrates a schematic view of a portion of an even further binding structure 2 according to the invention. The binding structure 2 basically corresponds to the one shown in FIG. 1E. A narrow portion 16 is, however, provided in the body portion 4 of the binding structure 2.

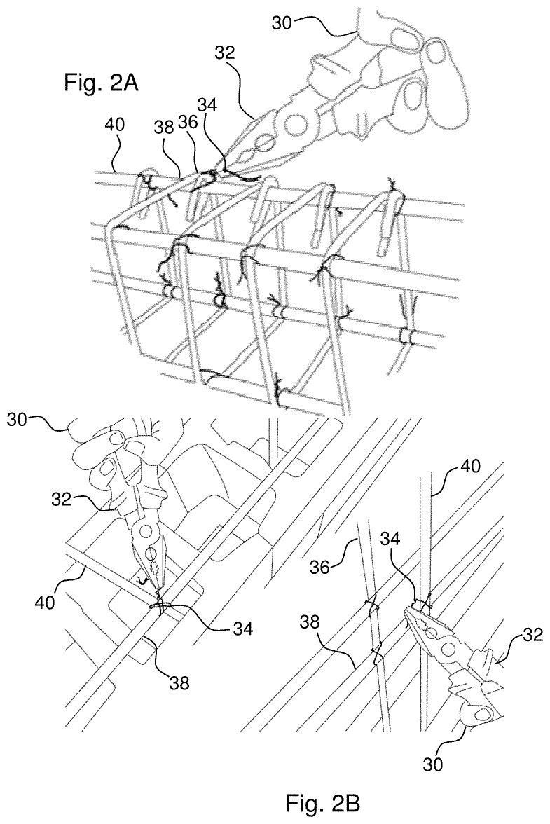

FIG. 2A illustrates a perspective view of reinforcement structures 36, 38, 40 that are being attached to each other using a prior art steel wire 34. A worker holds a tool (pliers) 32 in his hand 30. By means of the tool 32, the worker can bind/tie the wire 34 around the structures 36, 38, 40 to be attached to each other.

FIG. 2B illustrates how structures 36, 38, 40 can be attached to each other using a wire 34 and pliers 32.

This prior art way of attaching the structures 36, 38, 40 to each other is time consuming and requires two free hands. Accordingly, it would be desirable to have an alternative to this way of locking structures to each other.

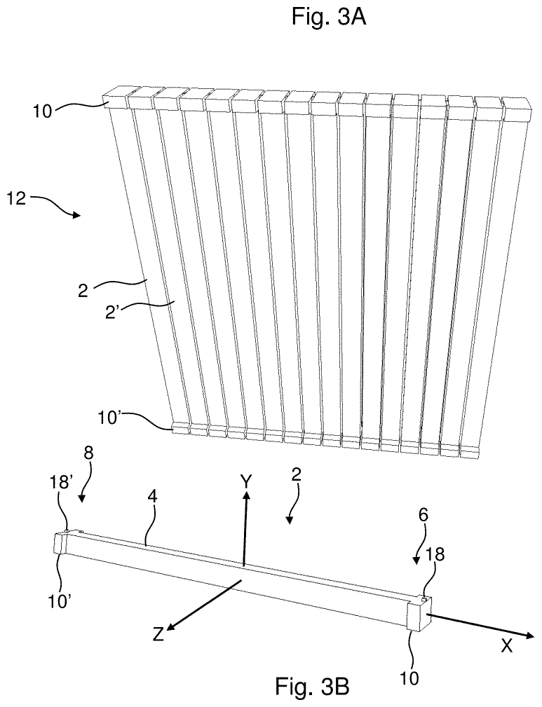

FIG. 3A illustrates a perspective view of a binding structure assembly 12 according to the invention. The binding structure assembly 12 comprises a plurality of binding structures 2 arranged side by side and attached to their neighboring binding structure 2′. Each binding structure 2, 2′ comprises an elongated body portion that extends, in a straight manner, between a first head portion 10 and a second head portion 10 of the binding structure 2, 2′.

Neighboring binding structures 2, 2′ are attached to each other by means of at least one micro joint 18, 18′, such as the ones shown in FIG. 3B. The micro joints 18, 18′ are provided at the head portions 10, 10′ of the binding structures 2, 2′ and protrude therefrom. Accordingly, adjacent binding structures 2, 2′ can be detached from each other by providing a force that pulls the binding structures 2, 2′ away from each other.

The head portions 10, 10′ protrude from the elongated body and hereby provide an attachment portion suitable for being used to maintain the binding structures 2, 2′ in a mounting device, such as the one shown in FIG. 7A.

FIG. 3B illustrates a perspective view of a binding structure 2 from the binding structure assembly 12 shown in FIG. 3A. It can be seen that the binding structure 2 comprises an elongated body portion 4 extending along the length and the longitudinal axis X of the binding structure 2.

In the first end portion 6 of the binding structure 2, a first, basically box-shaped head portion 10 is provided. The head portion 10 protrudes along a first lateral axis Z of the binding structure 2 and protrudes from the body portion 4. A micro joint 18 extends along a second lateral axis Y of the binding structure 2 and protrudes from the head portion 10.

At the second (opposite) end portion 8 of the binding structure 2, a second, basically box-shaped head portion 10′ is provided. The head portion 10′ protrudes along a first lateral axis Z of the binding structure 2 and protrudes from the body portion 4. A micro joint 18′ extends along a second lateral axis Y of the binding structure 2 and protrudes from the head portion 10. The body portion 4 has a uniform cross section (rectangular).

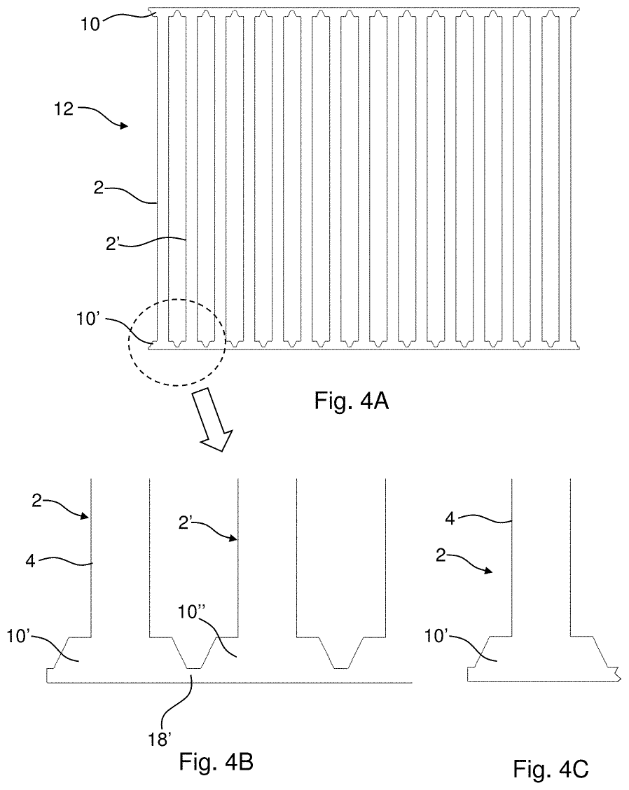

FIG. 4A illustrates a perspective view of a binding structure assembly 12 according to the invention. The binding structure assembly 12 comprises a plurality of binding structures 2 arranged side by side and attached to their neighboring binding structure 2′.

Every binding structure 2, 2′ comprises a straight elongated body portion that extends between a first head portion 10 and a second head portion 10′ of the binding structure 2, 2′.

Neighboring binding structures 2, 2′ are attached to each other in the first end portion by means of a first micro joint 18 and in the second (opposite) end portion by means of a second micro joint 18′.

The micro joints 18, 18′ are provided at the head portions 10, 10′ of the binding structures 2, 2′ and protrude therefrom. Therefore, adjacent binding structures 2, 2′ can be detached from each other by providing a force that pulls the binding structures 2, 2′ away from each other.

The head portions 10, 10′ constitute attachment portions that are suitable for being used to maintain the binding structures 2, 2′ in a mounting device, such as the one shown in FIG. 7A.

FIG. 4B illustrates a close-up view of the second end portion of the binding structure assembly shown in FIG. 4A. It can be seen that a first binding structure 2 is attached to a second adjacent binding structure 2′ by means of a micro joint 18′ extending between the adjacent head portions 10′, 10″ of the adjacent binding structures 2, 2′. The thickness of the micro joint 18′ may be selected so that the binding structure assembly can be stored, transported and handled without detachment of adjacent head portions 10′, 10″.

On the other hand, the thickness of the micro joint 18′ should be selected so that adjacent binding structures 2, 2′ can be pulled away from each other during use of the binding structure assembly.

In an embodiment, the thickness of the micro joint 18′ is 0.001-2.0 mm. In another embodiment, the thickness of the micro joint 18′ is 0.002-1.0 mm. In a further embodiment, the thickness of the micro joint 18′ is 0.004-0.8 mm.

FIG. 4C illustrates a close-up view of the second portion of a binding structure 2 according to the invention. The binding structure 2 has been detached from the other binding structure 2′ (shown in FIG. 4B).

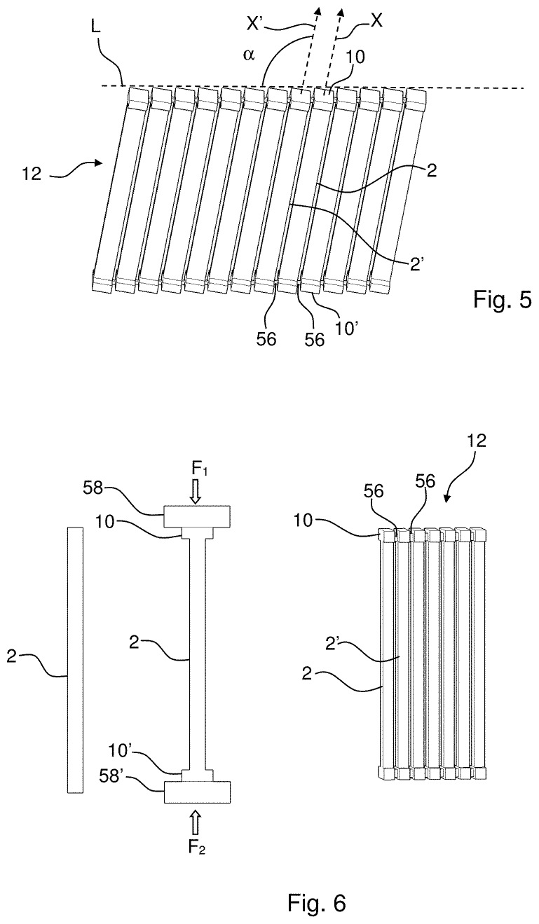

FIG. 5 illustrates a front view of a binding structure assembly 12 according to the invention. The binding structure assembly 12 comprises a plurality of binding structures 2, 2′ each comprising a straight elongated body portion that extends between a first head portion 10 and a second head portion 10′ of the binder structure 2, 2′. The binding structures 2, 2′ of the binding structure assembly 12 are arranged in such a manner that:
a) the binding structures 2, 2′ extend parallel to each other so that the longitudinal axes X, X′ of the binding structures 2, 2′ are parallel and
b) the head portions 10, 10′ of adjacent binding structures 2, 2′ extend along a line L that is angled with an angle α different from 90 degrees relative to the longitudinal axes X, X′ of the binding structures 2, 2′.

In an embodiment, the angle α is in the range 92-150 degrees. In the embodiment of FIG. 5 the angle α is approximately 110 degrees.

It can be seen that a joint structure 56 is provided between adjacent head portions 10, 10′ of the binding structures 2, 2′. The joint structure 56 may be a mechanical structure that is attached to and extends between the adjacent head portions 10, 10′. In an embodiment, the joint structures 56 may be glue arranged between adjacent head portions 10, 10′ to keep the adjacent head portions 10, 10′ attached to each other.

FIG. 6 illustrates a process for manufacturing a binding structure assembly 12 according to the invention. The manufacturing process is carried out by carrying out a first step, in which a plurality of binding structures 2, 2′ are provided. The binding structures 2, 2′ may be cut, stamped or punched out from a metal sheet (not shown). It can be seen that in the initial stage (after the first step) as shown to the left, the binding structure 2 comprises a straight elongated body portion.

The manufacturing process comprises a second step, in which the binding structure 2 is deformed under mechanical forces F₁, F₂ provided toward the end portions of the binding structure 2. This step (a mechanical processing) is carried out by using deformation tools 58, 58′ arranged and configured to provide the said forces F₁, F₂ and hereby deform the end portions of the binding structure 2. This deformation process leads to the formation of a first head portion 10 and a second head portion 10′.

The manufacturing process comprises a third step, in which the binding structures 2, 2′ are combined into a binding structure assembly 12. This may be done by using a joining agent. It can be seen that a joint structure 56 is provided between adjacent head portions 10, 10′ of the binding structures 2, 2′. The joint structure 56 may be a mechanical structure that is attached to and extends between the adjacent head portions 10, 10′.

In an embodiment, the joining agent is glue. In another embodiment, the joining agent is paper-based. In a further embodiment, the joining agent is plastic-based such as hot melt.

In an embodiment, the joining agent is based on mechanical attachment, e.g. such as the micro joints 18, 18′ illustrated in FIG. 4B

FIG. 7A illustrates a perspective view of a binding structure 2 according to the invention arranged in a mounting device 20. The binding structure 2 comprises an elongated body portion extending between a first head portion 10 and a second head portion 10′. The head portions 10, 10′ protrude from the body portion. The widths of the head portions 10, 10′ are larger than the width of the body portion.

The mounting device 20 comprises a base portion 22 provided at the distal end of the mounting device 20. The base portion 22 is equipped with a receiving opening 24 that is configured to receive and hold the head portion 10 of the binding structure 2.

The mounting device 20 comprises a twisted portion 26 extending between the base portion 22 and an end structure 28 provided at the opposite end of the mounting device 20. The mounting device 20 is configured to be displaced along a guide structure of an additional tool (e.g. an electrical tool) adapted to rotate the mounting device 20 upon displacing the mounting device 20 along its longitudinal axis X′.

FIG. 7B illustrates a close-up view of an end portion of a binding structure 2 arranged in the mounting device 20 shown in FIG. 7A. It can be seen that the head portion 10 of the binding structure 2 is held by two bracket structures 21, 21′. The bracket structures 21, 21′ are basically L-shaped and comprise two parallel holding structures. The holding structures may be provided as plate structures.

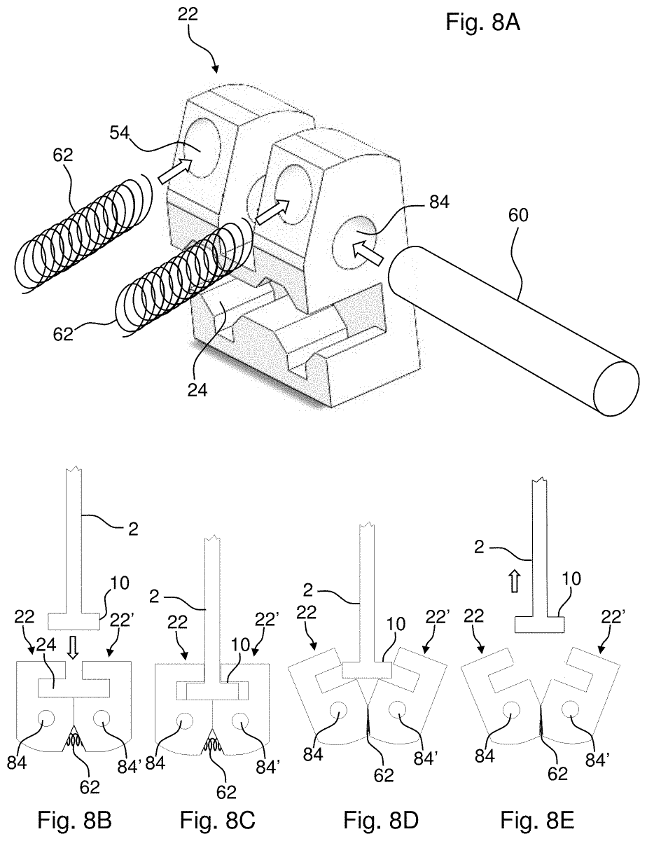

FIG. 8A illustrates a base portion 22 of a mounting device according to the invention.

FIG. 8B illustrates two base portions 22, 22′ of a mounting device according to the invention in a configuration in which no binding structure 2 has been attached to the base portions 22, 22′.

FIG. 8C illustrates the two base portions 22, 22′ shown in FIG. 8B in a configuration in which a binding structure 2 has been attached to the base portions 22, 22′.

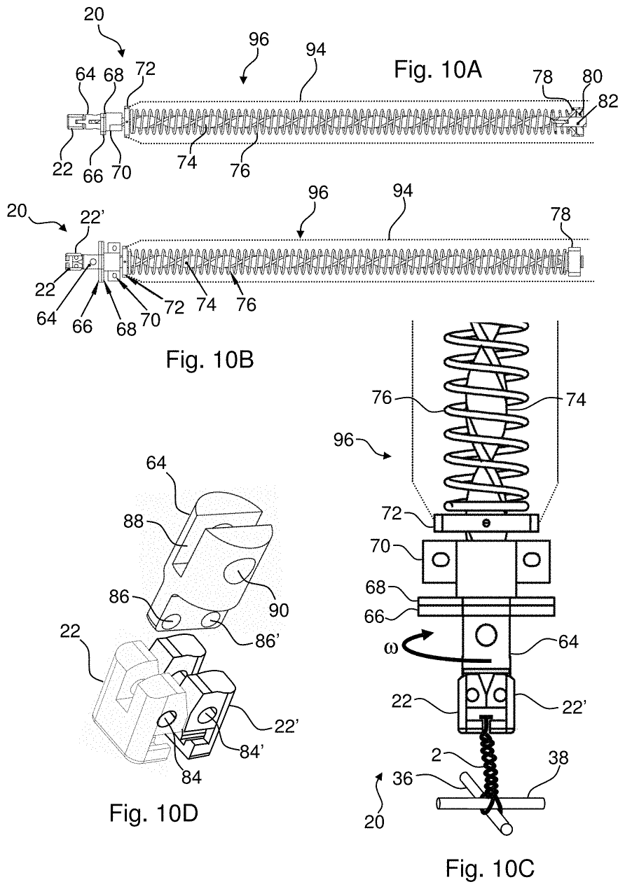

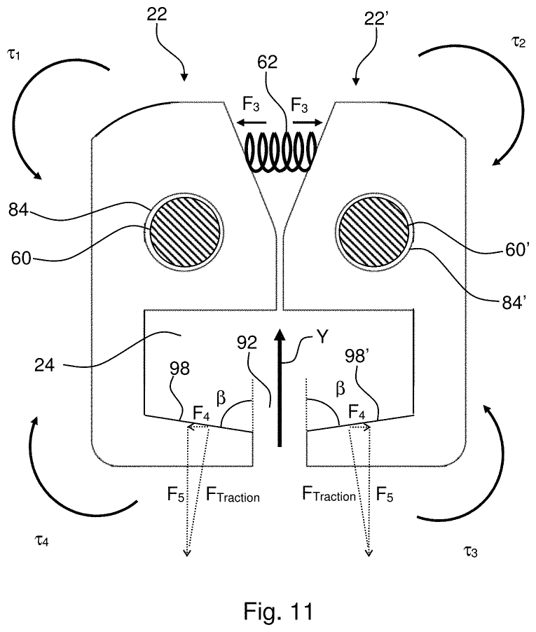

FIG. 8D illustrates the two base portions 22, 22′ shown in FIG. 8B and FIG. 10C in a configuration in which the base portions 22, 22′ have released the binding structure 2.

FIG. 8E illustrates the two base portions 22, 22′ shown in FIG. 8D in a configuration in which the base portions 22, 22′ have been removed from the binding structure 2. Each base portion 22 comprises receiving openings 24, wherein each receiving opening is shaped and configured to receive and hold a head portion of a binding structure.

Each base portion 22 comprises two cavities 54 extending parallel to each other and being provided above the receiving openings 24. Each of the cavities is configured to receive a spring 62.

Each base portion 22, 22′ comprises a through-going bore 84, 84′ that is configured to receive a corresponding shaft 60 so that the base portion 22, 22′ can be rotatably mounted. Each base portion 22, 22′ is configured to be displaced along a guide structure of an additional tool shown in and explained with reference to FIG. 10A, FIG. 10B and FIG. 10D. Accordingly, the mounting device is adapted to be rotated upon being displaced along its longitudinal axis.

Upon rotation of the base portions 22, 22′ along the longitudinal axis of the binding structure 2, a force that will cause the base portions 22, 22′ to open is gradually built up. The springs 62, however, will provide a force that rotates the base portions 22, 22′ towards each other. Once the base portions 22, 22′ have been rotated to a certain level, the force that causes the base portions 22, 22′ to open exceeds the force that closes the base portions 22, 22′. Accordingly, upon rotation of the base portions 22, 22′, the base portions 22, 22′ will eventually be released as shown in FIG. 10D and FIG. 11. The mounting device is preferably constructed in such a manner that the base portions 22, 22′ are released when the binding structure is sufficiently tied together.

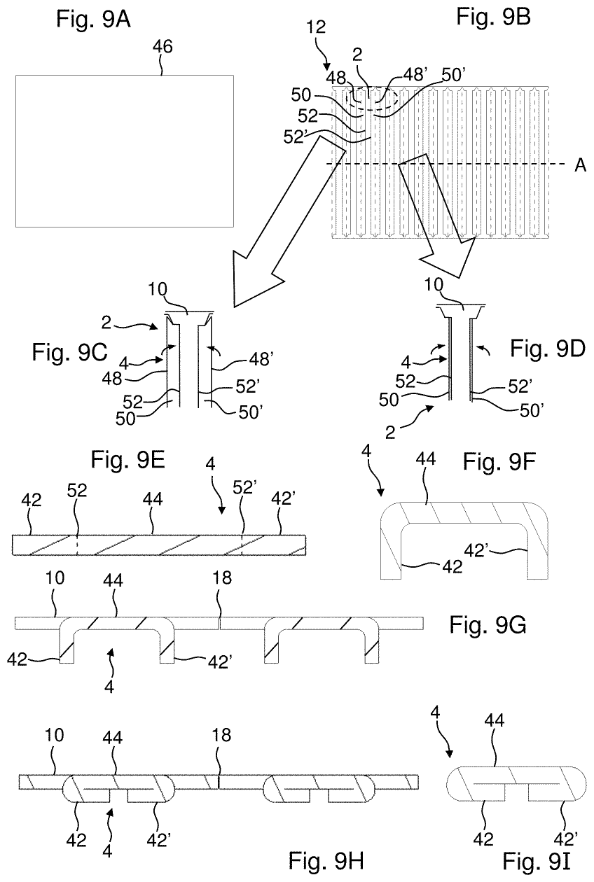

FIG. 9A illustrates a metal sheet 46 from which binding structures according to the invention can be made. The metal sheet 46 may be cut from a metal roll.

FIG. 9B illustrates a binding structure assembly 12 made from the metal sheet 46 shown in FIG. 9A after a punching process has been carried out. It can be seen that the binding structure assembly 12 is provided in a sheet-like structure. The binding structure assembly 12 comprises a plurality of binding structures 2 having the same geometry and length. The binding structures 2 are provided next to each other in a manner, in which a micro joint is provided between adjacent head portions of the binding structures 2.

Each binding structure 2 is provided with two parallel punching lines 48, 48′ (indicated by dotted lines) and parallel bending lines 52, 52′. The side portions 50, 50′ of the elongated body portion of each binding structure are configured to be bent along its corresponding bending line 52, 52′. Accordingly, almost the entire metal sheet 46 is used (almost no metal is wasted during the manufacturing process). A cross section line A is indicated.

FIG. 9C illustrates a close-up view of a portion of a binding structure 2 from the binding structure assembly shown in FIG. 9B. It can be seen that the head portion 10 has been separated from its surroundings and that a small gap is provided between the head portion 10 and the (side portions 50, 50′ of the) elongated body portion 4. The bending lines 52, 52′ of the elongated body portion 4 are shown in FIG. 9C. It can be seen that the side portions 50, 50′ of the elongated body portion 4 can be bent (rotated with respect to the bending lines 52, 52′) as indicated with the arced arrows to achieve the configuration shown in FIG. 9D.

FIG. 9D illustrates the binding structure 2 shown in FIG. 9C in a configuration in which the side portions 50, 50′ of the elongated body portion 4 have been bent (rotation about the corresponding bending line 52, 52′). Accordingly, the head portion 10 protrudes radially from the body portion 4.

FIG. 9E illustrates a cross-sectional view (cross section along the line A shown in FIG. 9B) of the elongated body portion 4 of the binding structure shown in FIG. 9C. It can be seen that the elongated body portion 4 comprises a centrally arranged body portion 44 placed between two bent portions 42, 42′ that have not yet been bent.

FIG. 9F illustrates the cross-sectional view of the elongated body portion 4 of the binding structure shown in FIG. 9D in a configuration in which the bent portions 42, 42′ are bent (90 degrees relative to the longitudinal axis of the end body portion 44).

FIG. 9G illustrates a cross-sectional view of two binding structures each having an elongated body portion like the binding structure shown in FIG. 9D. It can be seen that the head portion 10 protrudes radially from the body portion 4 and that the bent portions 42, 42′ have been bent 90 degrees relative to the longitudinal axis of the end body portion 44. Besides, a micro joint 18 is provided between the two adjacent binding structures.

FIG. 9H illustrates a cross-sectional view of two binding structures 4 according to an embodiment of the invention. The head portion 10 protrudes radially from the body portion 4 and the bent portions 42, 42′ have been bent 180 degrees relative to the longitudinal axis of the end body portion 44. Besides, a micro joint 18 is provided between the two adjacent binding structures.

FIG. 9I illustrates a cross-sectional view of the elongated body portion of a binding structure 4 shown in FIG. 9H. It can be seen that the bent portions 42, 42′ are bent 180 degrees relative to the longitudinal axis of the end body portion 44.

FIG. 10A, FIG. 10B and FIG. 10C illustrate different views of a mounting device 20 according to the invention. The mounting device 20 comprises a rotation member 96 comprising a helical structure 74 extending inside a surrounding spring 76. The helical structure 74 is rotatably mounted in a bearing 80 that is mounted in a bearing housing 78. The distal end of the helical structure 74 is attached to a stag 82 that is attached to the bearing 80.

The mounting device 20 comprises a profiled member 72 surrounding the helical structure 74 and having a profile that matches the geometry of the cross-sectional profile of the helical structure 74. Accordingly, when the profiled member 72 is pulled along the longitudinal axis of the mounting device 20, the helical structure 74 will be rotated due to the retraction of the profiled member 72.

The helical structure 74 is attached to a guide structure 70 that is attached to a joint member 64. The joint member 64 is attached to the base portions 22, 22′. A metal plate 66 and a resilient member formed as a rubber plate 68 are sandwiched between the guide structure 70 and the joint member 64.

The mounting device 20 comprises a pull structure 94 attached to the profiled member 72 and arranged and configured to translate the profiled member 72 along the length of the mounting device 20. Accordingly, when the pull structure 94 and the profiled member 72 are displaced along the length of the mounting device 20, the helical structure 74 will be rotated and thus the base portions 22, 22′ will be rotated with the same rotational velocity ω as the helical structure 74. Thus, the mounting device 20 can easily mount binding structures 2 according to the invention and release the binding structure 2 when mounted. The surrounding spring 76 will return the pull structure 94 to its starting position (the one shown in FIG. 10A, FIG. 10B and FIG. 10C).

In FIG. 10C it can be seen that the mounting device 20 is being used to mount a binding structure 2 to a couple of rebars 36, 38.

FIG. 10D illustrates a close-up view of a joint member 64 and two base portions 22, 22′ of a mounting device according to the invention. The two base portions 22, 22′ are equally shaped and arranged with the front facing each other. Each base portion 22, 22′ comprises a through-going bore 84, 84′ arranged in such a manner that two through-going bores 86, 86′ provided in the flat distal portion of the joint member 64 can receive two parallel shafts inserted through the through-going bores 84, 84′ of the base portion 22, 22′. The joint member 64 comprises a slotted portion 88 configured to receive a protruding flat structure of the guide structure 70. The guide structure 70 is configured to be attached to the joint member 64 by means of a pin (shaft) inserted into a through bore 90 provided in the joint member 64.

FIG. 11 illustrates a side view of two base portions 22, 22′ of a mounting device corresponding to the one shown in FIG. 10A, FIG. 10B, FIG. 10C and FIG. 10D. The first (left) base portion 22 is rotatably mounted by means of a shaft 60 extending through the through bore 84. Likewise, the second (right) base portion 22′ is rotatably mounted by means of a shaft 60′ extending through the through bore 84′.

A spring 62 extends between the base portions 22, 22′ and provides an outwardly directed force F₃ that induces:
1) a torque τ₁ that creates an anticlockwise rotation of the first base portion 22 and
2) a torque τ₂ that creates a clockwise rotation of the second base portion 22′. Accordingly, the spring 62 provides a force F₃ that closes the base portions 22, 22′.

During use of the mounting device, a binding structure is received and held inside the receiving openings 24 of the base portions 22, 22′. During rotation of the binding structure along the longitudinal axis Y of the mounting device, the binding structure will gradually provide a force F₄ of increasing size. This force F₄ will induce:
3) a torque τ₃ that creates a clockwise rotation of the first base portion 22 and
4) a torque τ₄ that creates an anticlockwise rotation of the second base portion 22′.

Accordingly, the rotation of the binding structure will eventually cause the opening of the base portions 22, 22′ so that the outlet 92 is wide enough to release the head portions of the binding structure.

When pulling the binding structure along the longitudinal axis Y of the mounting device, the head portion of the binding structure will provide a tractive force F_{Traction} towards the contact surfaces 98, 98′ indicated in FIG. 11. In an embodiment, the angle β between the contact surfaces 98, 98′ and the longitudinal axis is less than 90 degrees. Hereby, the tractive force F_{Traction} will have a component F₅ extending along longitudinal axis Y of the mounting device and a component F₄ extending perpendicular to the longitudinal axis Y of the mounting device.

### LIST OF REFERENCE NUMERALS

2, 2′ Binding structure
4 Elongated body portion
6 First end portion
8 Second end portion
10, 10′, 10′″ Head portion
12 Binding structure assembly
14 Intermediate structure
16 Narrow portion
18, 18′ Micro joint
20 Mounting device
21, 21′ Bracket structure
22 Base portion
24 Receiving opening
26 Twisted portion
28 End structure
30 Hand
32 Tool (pliers)
34 Wire
36 Rebar
38 Rebar
40 Rebar
42, 42′ Bent portion
44 Body portion
46 Sheet
48, 48′ Punching line
50, 50′ Side portion
52, 52′ Bending line
54 Cavity for springs
56 Joint structure
58, 58′ Deformation tool
60, 60′ Shaft
62 Spring
64 Joint member
66 Metal plate
68 Resilient member (e.g. rubber plate)
70 Guide structure
72 Profiled member
74 Helical structure
76 Surrounding spring
78 Bearing housing
80 Bearing
82 Stag
84, 84 Through bore
88 Slotted portion
90 Through bore
92 Outlet
94 Pull structure
96 Rotation member
98, 98′ Contact surface
A Cross section line
D₁, D₂, D₃ Width
X, Y, Z, X′ Axis
α Angle
F₁, F₂, F₃, F₄ Force
F₅, F_{Traction} Force
X, X′, Y Longitudinal axis
L Line
τ₁, τ₂, τ₃, τ₄ Torque
ω Rotational velocity

What is claimed is:

1. A binding structure assembly comprising:
a plurality of binding structures configured for attaching two structures to each other, said plurality of binding structures constructed as a one-piece body having a sheet-like structure, wherein each binding structure comprises an elongated body portion having a first end portion and a second end portion with head portions provided on each of the first end portion and the second end portion;
wherein said head portions are identical to one another and protrude radially from the elongated body portion.

2. The binding structure assembly according to claim 1, wherein the binding structures are made by a stamping, punching or cutting process.

3. The binding structure assembly according to claim 1, wherein the binding structures comprise an intermediate structure provided between the first end portion and the second end portion, wherein a width of a portion of the intermediate structure is smaller than a width of the head portions.

4. The binding structure assembly according to claim 1, wherein the elongated body portion comprises a uniform cross section.

5. The binding structure assembly according to claim 1, wherein the elongated body portion is provided with a narrow portion having a smaller width than a remaining part of the elongated body portion.

6. The binding structure assembly according to claim 1, wherein the binding structures are made of metal.

7. The binding structure assembly according to claim 1, wherein the binding structures are made of heat-treated steel.

8. The binding structure assembly according to claim 1, wherein the binding structures have the same geometry and length as one another and are provided next to each other.

9. The binding structure assembly according to claim 8, wherein the binding structures in the binding structure assembly are arranged such that:
a) longitudinal axes of the binding structures extend parallel to each other; and
b) the head portions of adjacent binding structures extend along a line that is angled with an angle different from 90 degrees relative to the longitudinal axes of the binding structures.

10. The binding structure assembly according to claim 8, wherein a micro joint is provided between adjacent head portions.

11. The binding structure assembly according to claim 9, wherein a micro joint is provided between adjacent head portions.

12. A mounting device for tying together a binding structure of a binding structure assembly, the mounting device comprising:
a gripping portion configured to receive and hold the head portions of the binding structures; and
a rotation member configured to rotate the gripping portion;
wherein, upon movement of the rotation member along a longitudinal axis of the mounting device, the gripping portion is configured to be automatically arranged in:
a) a closed configuration, in which the gripping portion maintains the binding structure; and
b) an open configuration, in which the gripping portion releases the binding structure;
wherein the open configuration is achieved upon further displacing the rotation member along the longitudinal axis of the mounting device when the mounting device has initially been arranged in the closed configuration.

13. The mounting device according to claim 12, wherein the gripping portion comprises:
a first base portion rotatably attached to a joint member by means of a first shaft and
a second base portion rotatably attached to the joint member by means of a second shaft, wherein the first shaft and the second shaft extend parallel to each other.

14. The mounting device according to claim 13, wherein a spring extends between the first base portion and the second base portion.

15. The mounting device according to claim 13, wherein each of the first base portion and the second base portion comprises a receiving opening configured to simultaneously receive:
a part of a first head portion of the binding structure; and
a part of a second head portion of the binding structure,
wherein the receiving opening is equipped with:
a first recess configured to receive and maintain said part of the first head portion of the binding structure in a fixed position of the base portion; and
a second recess configured to receive and maintain said part of the second head portion of the binding structure in a fixed position of the base portion.

16. The mounting device according to claim 14, wherein each of the first base portion and the second base portion comprises a receiving opening configured to simultaneously receive:
a part of a first head portion of the binding structure; and
a part of a second head portion of the binding structure,
wherein the receiving opening is equipped with:
a first recess configured to receive and maintain said part of the first head portion of the binding structure in a fixed position of the base portion and
a second recess configured to receive and maintain said part of the second head portion of the binding structure in a fixed position of the base portion.

17. A method for binding together two ends of a binding structure using a mounting device, the method comprising:
organizing a first head portion and a second head portion of the binding structure around two or more structures to be tied together;
placing the first head portion and the second head portion in a gripping portion of the mounting device; and
rotating the gripping portion along a longitudinal axis of a rotating member of the mounting device.

18. The method of claim 17, wherein the step of rotating continues until the first head portion and the second head portion are automatically released from the gripping portion.

19. The method of claim 17 further comprising breaking at least one micro joint between the binding structure and a neighboring binding structure in a binding structure assembly.

20. The method of claim 17 further comprising:
stamping, punching, or cutting the binding structure from a metal blank; and
leaving at least one micro joint between the binding structure and a neighboring binding structure.
